(19) United States
(12) Patent Application Publication
(10) Pub. No.: US 2024/0225015 A1
(43) Pub. Date: Jul. 11, 2024

(54) Feed Roller with Raised Portions for Feeding Dough to Mold Roller

(71) Applicant: General Mills, Inc., Minneapolis, MN (US)

(72) Inventors: Gary O. Bendickson, Clear Lake, MN (US); Molly Moen, Rosemount, MN (US); Olivia Murch, Minneapolis, MN (US); Emily A. Ryks, Maple Grove, MN (US); Ralph A. Stenvik, Plymouth, MN (US); Keegan Withey, Hopkins, MN (US)

(21) Appl. No.: 18/093,462

(22) Filed: Jan. 5, 2023

(51) Int. Cl. A21C 11/08; A21C 1/00; A21C 1/08

(52) U.S. Cl. CPC A21C 11/08; A21C 1/006; A21C 1/08

(57) ABSTRACT

A feed roller is formed with a generally cylindrical outer surface having raised portions arranged in a pattern that extends circumferentially around the surface. The raised portions are formed in distinct shapes. Preferably the distinct shapes are chevron shapes that retain dough between successive chevron shapes. The roller preferably has an annular ridge which prevents dough from escaping axially off the edge of the roller. In use, dough is feed between the feed roller and a mold roller. Some of the dough is retained on the outer cylindrical surface of the feed roller to provide a smooth surface for inserting the rest of the dough in mold cavities located in the mold roller.

### BACKGROUND OF THE INVENTION

The invention pertains to the art of feed rollers used in the food production industry and, more particularly, to producing edible dough products with rollers.

Food manufacturers often make large quantities of dough-based products. To do so, the manufacturers often employ machinery that moves dough from a hopper or other source of dough through processing rollers to form dough products which are then placed onto a conveyer and sent into an oven for baking. However, many different types of rollers are employed during the manufacture of food. In each case the roller has an outer surface with a specific structure designed for a particular role. For example, feed rollers have patterns for pushing dough into mold rollers. Usually, the pattern includes simple longitudinal ridges extending from the surface.

In some arrangements, a combination of a feed roller with ridges and a mold roller with die cavities work together to process dough. The shape of the die cavities determines the shape of the final dough products. For instance, some mold rollers are used in producing round cookies, while other mold rollers produce polygonal-shaped cookies or other baked dough products. Problems can occur when the surface of a feed roller encounters different types of dough. In particular, a feed roller designed for one type of dough might damage another type of dough as the dough is passed between the feed roller and the mold roller. In some cases, the dough may simply be forced axially out between the feed and mold rollers so that some of the dough escapes axially instead of passing between the rollers. In other cases, such as when utilizing doughs containing particulates, feed roller arrangements not specifically designed to accommodate the particulates will undesirably crush the particulates during processing. With the above in mind, there exists a need in the art for a feed roller that can address these problems.

### SUMMARY OF THE INVENTION

The invention is directed to a feed roller comprising a main body establishing a generally cylindrical outer surface having a first end and a second end and extending in a circumferential direction. The generally cylindrical outer surface is configured to press dough against a second roller, such as a mold roller. In accordance with a preferred embodiment of the invention, the generally cylindrical outer surface has raised portions forming distinct shapes that are arranged in a pattern that extends circumferentially around the generally cylindrical outer surface. The raised portions are configured to retain some of the dough on the generally cylindrical outer surface while pressing a remainder of the dough on the generally cylindrical outer surface against a mold roller.

The feed roller further comprises a central shaft integrally formed with the main body as one solid roller. In a preferred embodiment, the main body extends radially outward from the shaft and forms the generally cylindrical outer surface. In a further preferred embodiment, the distinct shapes are chevron shapes with each chevron shape formed of two diagonal stripes of raised portions meeting at a point and forming an angle, i.e., generally v-shaped. Preferably, the chevron shapes rise from the outer surface to a height ranging between 1 and 5 mm, more preferably between 3 and 3.6 mm. Also, each of the chevron shapes has a width ranging between 5 and 15 mm, more preferably between 9 and 9.6 mm or alternatively 3 to 10 degrees along an arc on the generally cylindrical outer surface. A plurality of chevron shapes can be established and arranged in the pattern, extending circumferentially around the generally cylindrical outer surface. For example, 40 chevron shapes are preferably equally spaced around the generally cylindrical outer surface and, therefore, are located about 9 degrees of rotation apart from the center of one chevron shape to the center of the next chevron shape. Each chevron shape, of the plurality of chevron shapes, is circumferentially separated by a gap that is approximately the same distance as the width, i.e., the distance the chevron shape extends circumferentially about the outer surface. Preferably, the width is in the order of 4 to 5 degrees of rotation. As a preferred example, a roller with a circumference of approximately 744 mm, with 40 chevron shapes, has chevron shapes with a width of approximately 9.3 mm. The gap between each chevron shape is between 5 and 15 mm, more preferably between 9 and 9.6 mm.

Preferably, the plurality of chevron shapes extends the entire longitudinal length of the roller. Alternatively, the plurality of chevron shapes constitutes a first plurality of chevron shapes, and the chevron shapes include a second plurality of chevron shapes which are also arranged circumferentially around the surface.

In another preferred embodiment, the feed roller includes a first hollow shell mounted on the central shaft and two additional hollow shells are provided with patterns of longitudinally extending ridges. However, the patterns on the additional hollow shells are preferably different from the pattern on the first hollow shell and the patterns are also preferably different from each other. For example, the longitudinal ridges may be longer and wider on the additional hollow shells when compared to those on the first shell.

In yet another preferred embodiment, the patterns on the feed roller preferably take on several shapes distinct from longitudinal ridges. For example, sinusoidal curves extending around the cylindrical surface may be employed.

An annular ring is preferably formed on the circumferentially extending outer surface between the plurality of raised portions forming distinct shapes and the first end of the generally cylindrical outer surface. Preferably, the annular ring extends to the first end of the generally cylindrical outer surface and is configured to retain dough on the feed roller during use. Alternatively, the plurality of raised portions forming distinct shapes extends to the first end of the generally cylindrical outer surface.

A method of molding dough in accordance with the invention includes feeding dough between the feed roller and the mold roller while initially retaining some of the dough on the generally outer cylindrical surface of the feed roller with the raised portions of the roller and inserting the rest of the dough, i.e., the dough not retained by the raised portions, in mold cavities located on the mold roller. Retaining some dough between the distinct shapes also causes the dough to form a smooth, outermost surface. With this arrangement, the dough is advantageously protected while being inserted in the mold cavities because the dough is cushioned by the smooth surface. As a result, any particulates located within the dough are not crushed during processing. The method further comprises preventing the dough from escaping off of the roller with the annular ring. As a result, the dough can be moved quickly and efficiently between the feed roller and mold roller.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 shows a perspective view of a portion of a production line for producing dough pieces showing a set of rollers, including a feed roller with chevron shapes on its outer surface and a mold roller of a molding machine, constructed in accordance with a preferred embodiment of the invention.

FIG. 2 shows an enlarged perspective view of a portion of the feed roller shown in FIG. 1.

FIG. 3 shows a partial cross section of the roller of FIG. 2.

FIG. 4 shows a perspective view of a roller with a pattern of longitudinally extending ridges on the outer surface.

FIG. 5 shows a perspective view of a roller with a pattern of sinusoidal ridges on the outer surface.

FIG. 6 shows a perspective view a roller, having chevron shapes in patterns on its outer surface.

FIG. 7 shows a perspective view the roller, having chevron shapes in patterns on its outer surface and an annular ridge.

FIG. 8 shows the roller of FIG. 6 with dough located between the chevron shapes.

### DETAILED DESCRIPTION OF EMBODIMENTS

The following detailed description should be read with reference to the drawings in which similar elements in different drawings are numbered the same. The detailed description and the drawings, which are not necessarily to scale, set forth illustrative and exemplary embodiments and are not intended to limit the scope of the disclosure. Selected features of any illustrative embodiment can be incorporated into an additional embodiment unless clearly stated to the contrary. While the disclosure is amenable to various modifications and alternative forms, specifics thereof have been shown by way of example in the drawings and will be described in detail. As used herein in the specification and claims, including as used in the examples and unless otherwise expressly specified, all numbers may be read as if prefaced by the word “about” or “approximately,” even if the term does not expressly appear, with it being understood that this provides a reasonable expected range of values in the order of +/−10% of the stated value (or range of values). In addition, any numerical range recited herein is intended to include all sub-ranges subsumed therein. Overall, it should be understood, however, that the intention is not to limit aspects of the disclosure to the particular illustrative embodiments described. On the contrary, the intention is to cover all modifications, equivalents, and alternatives falling within the spirit and scope of the disclosure.

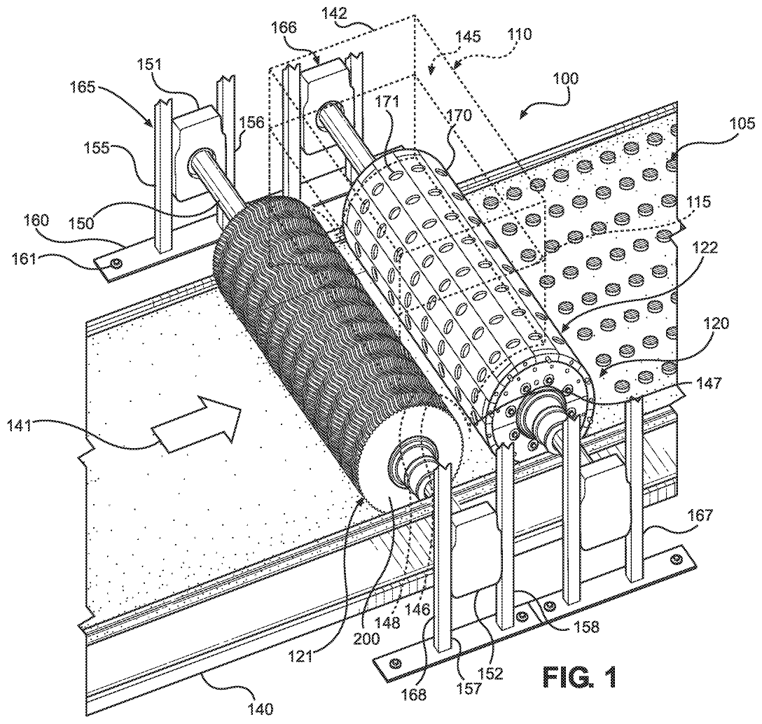

FIG. 1 shows a perspective view of a portion of a production line, including a molding machine 100 for producing dough pieces 105, showing a hopper 110 (in phantom) feeding dough 115 to a set of rollers 120. The set of rollers 120 include a feed roller 121 and a mold roller 122, with the set of rollers 120 mounted in the molding machine 100 so as to create and direct the dough pieces 105 along a conveyor 140 in the direction of arrow 141 to an oven, not shown.

The hopper 110 is seen mounted at the top of the molding machine 100 in a conventional manner. The hopper 110 is shown in a hidden view to show the set of rollers 120, more clearly. The hopper 110 is configured to receive dough at an upper portion 142 and to temporarily store the dough 115 until the dough 115 is needed. The hopper 110 has a main storage area 145 centrally located in the hopper 110 and a dispenser 146 located at the bottom portion of the hopper 110. The dispenser 146 is formed of two converging walls 147, 148 and a scraper (not shown for clarity) all work together to place dough 115 between the set of rollers 120, as described below.

The first roller is the feed roller 121 which is rotatability mounted on a central shaft 150 supported by first and second bearing assemblies 151, 152. Preferably first bearing assembly 151 is mounted at one end of the central shaft 150, between two vertically extending supports 155, 156. Likewise, second bearing assembly 152 is mounted at the opposite end of central shaft 150 and mounted between two vertically extending supports 157, 158. Bearing assemblies 151, 152 are preferably vertically adjustable and may be mounted at a desired height. The vertically extending supports 155, 156 are preferably connected to a horizontal stand 160. The horizontal stand 160 is preferably mounted to a secure surface, such as a factory floor (not separately labelled) with fasteners 161. The horizontal stand 160, vertically extending supports 155, 156 and bearing assembly 151 all constitute a first support assembly 165. Three additional support assemblies 166, 167, 168, preferably constructed in a corresponding manner to first support assembly 165, are provided at the ends of the feed roller 121, and mold roller 122 such that the set of rollers 120 is supported for rotation above the conveyor 140. The set of rollers 120 can either be positively driven by the bearing assemblies 151, 152 or simply be driven by the frictional engagement between the set of rollers 120 and the conveyor 140.

Mold roller 122 is formed with a plurality of cavities 170 that are spaced and function as dies. The cavities 170 are arranged in a series of circumferential rows 171, which are longitudinally spaced. The cavities 170 are also aligned longitudinally with mold roller 122. The cavities 170 may be round to produce dough pieces 105 that are round, or the cavities 170 may be of any desired shape so as to produce dough products of other shapes. Preferably, the cavities 170 are made of a stainless-steel alloy to reduce wear or a nonstick material to allow for easy release of the dough 115 from cavities 170. Other materials, such as food safe plastic, can also be employed especially when the cavities 170 are formed with a 3D printer. Additional details of a molding machine are described in U.S. Pat. No. 3,205,837 and European Patent No. 1008299, both of which are incorporated herein by reference.

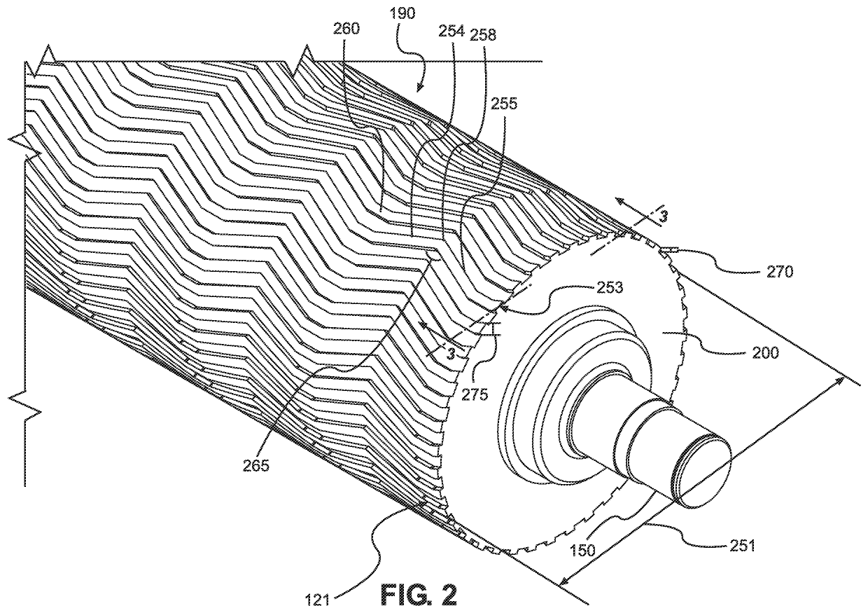

The feed roller 121, shown in more detail in FIG. 2. Feed roller 121 is shown with a generally cylindrical outer surface 190 formed by a solid main body 200 formed with central shaft 150 and having a diameter 251. A pattern of distinct chevron shapes 253 is formed on generally cylindrical outer surface 190. Each of the chevron shapes 253, is formed with diagonal legs 254 and 255, which meet at a point 258 and form an angle 265 therebetween. The inventors have discovered that while the angle 265 that forms the chevron shapes 253 does not affect performance of the chevron shapes 253, the width 275 and height 270 of the chevron shapes 253 do affect the efficient feeding of dough 115, particularly when conducting piston or rotary molding. The chevron shapes 253 extend circumferentially around the surface 190. The chevron shapes 253 are connected to each other by joints 260, so that the pattern extends longitudinally and continuously the entire length of the generally cylindrical outer surface 190.

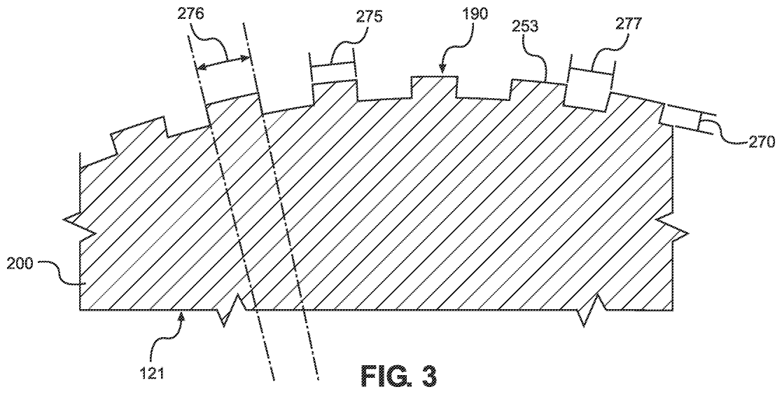

Turning now to FIG. 3, the roller 121 is shown in partial cross section so that the chevron shapes 253 can be seen in cross section. The chevron shapes 253 rise to a height 270, which preferably ranges between ranging between, 1 and 5 mm, more preferably between 3 and 3.6 mm. Each of the chevron shapes 253 have a width 275, which preferably ranges between 3 and 15 mm, more preferably between 9 and 9.6 mm or most preferably 9.3 mm. Measured another way the width extends 3 to 10 degrees, or more preferably approximately 4.5 degrees along an arc 276 on the cylindrical outer surface 190. For example, if the diameter 251 of the roller is approximately 237 mm and the circumference is approximately 744.5 mm then 4.5 degrees rotation along the circumferential surface 190 would be about 9.3 mm. A gap 860, in the order of 5 to 15 mm and more preferably, 9 to 9.6 mm long is formed between the chevron shapes 253.

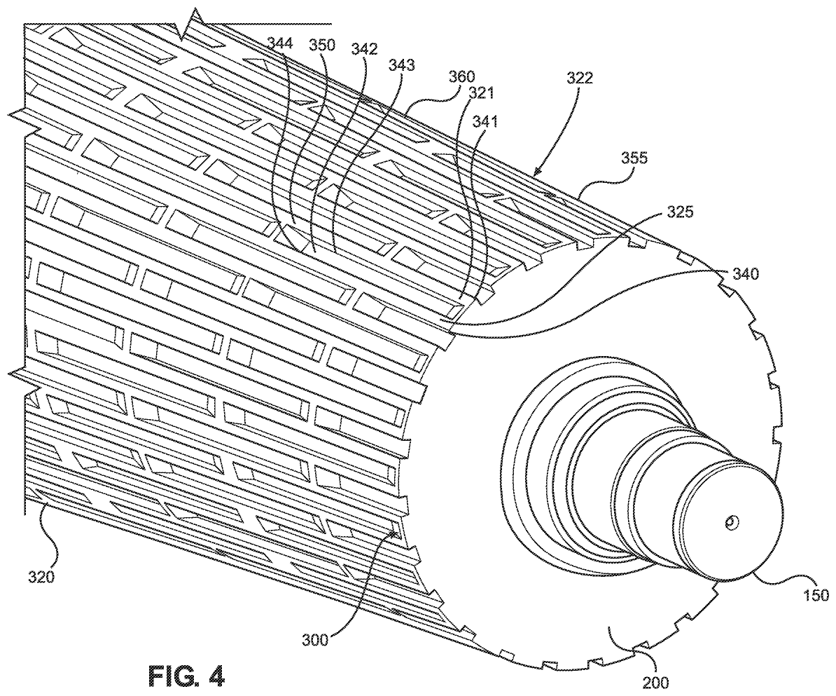

FIG. 4 shows a feed roller 300 with an alternative pattern of upstanding, longitudinal ridges 321 on an outer surface 322 of the feed roller 300. In any case, the ridges 321 may have varying and/or repeating patterns. With specific reference to the outer surface 322, an exemplary, upstanding ridge 325 extends radially out from the outer surface 322 of the feed roller 300 and extends longitudinally along the feed roller 300. Preferably, exemplary ridge 325 is provided with smooth sidewalls 340, 341. The ridges 321 may also have recesses 342 with side walls 343, 344. The side walls 343, 344 rise to a raised portion or top surface 350 forming a plateau. The ridges 321 may be of the same shape or different shapes, and several of the ridges 321 may form a repeating pattern around the outer surface 322. The overall pattern or panel design of the outer surface 322 may differ depending on the material to be fed by the feed roller 300. For example, the longitudinal ridges 321 may be longer and wider on section 355 when compared to those on section 360.

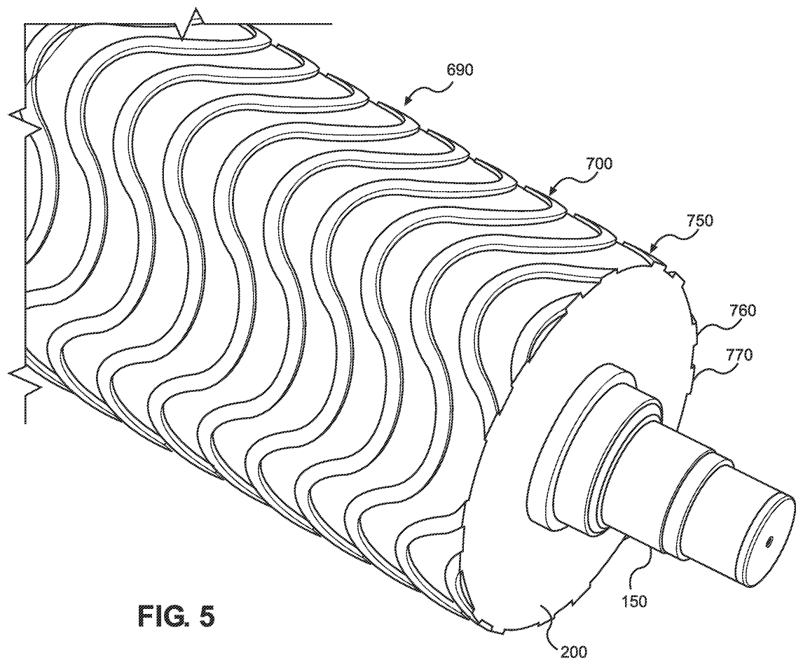

With reference to FIG. 5, there is shown a generally cylindrical outer surface 690 of another embodiment formed on a feed roller 700. The outer surface 690, and optionally the central shaft 150, constitute a main body forming the generally cylindrical outer surface 690. The generally cylindrical outer surface 690 is configured to press dough 115 against a second roller such as mold roller 122. A pattern of distinct shapes 750, for example, sinusoidal curves is formed by raised portions 760. The pattern of distinct shapes 750 extends circumferentially around the generally cylindrical outer surface 690 and longitudinally to a first end 770 of the generally cylindrical outer surface 690. As with the embodiment described above, the pattern of distinct shapes 750 is configured to retain some of the dough 115 on the generally cylindrical outer surface 690.

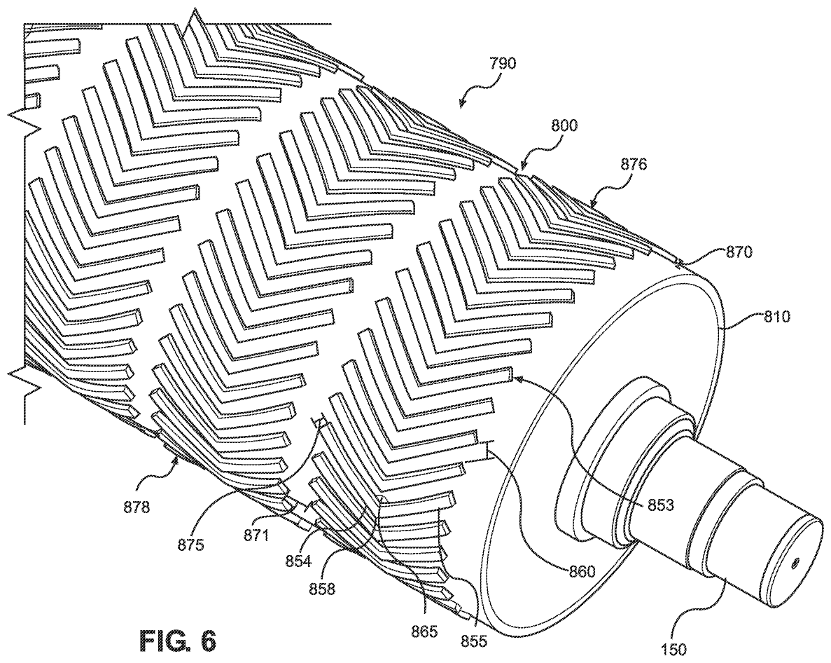

With reference to FIG. 6, there is shown another generally cylindrical outer surface 790 formed on a feed roller 800. At this point, it should be noted that instead of the single solid roller 121, the feed roller 800 may be formed with a single outer shell 810 could also be employed to form the outer surface 790. Also, a pattern of distinct chevron shapes 853 is formed instead of sinusoidal curves. Each of the chevron shapes 853, is formed with diagonal legs 854 and 855, which meet at a point 858 and form an angle 865 therebetween. The chevron shapes 853 are circumferentially separated from each other by a gap 860, the gap being in the order of 5 to 15 mm and more preferably, 9 to 9.6 mm long. The chevron shapes 853 rise to a height 870, which preferably ranges between ranging between 1 and 5 mm, more preferably between 3 and 3.6. Each of the chevron shapes 853 have a width 875, which preferably ranges between 5 and 15, more preferably between 9. and 9.6.

The inventors have discovered that, in a similar manner to the embodiments discussed above, the angle 865 that forms the chevron shapes 853 does not affect performance of the chevron shapes 853, the width 875 and height 870 of the chevron shapes 853 do affect the efficient feeding of dough 115, particularly when conducting piston or rotary molding. The chevron shapes 853 include a first plurality of chevron shapes 876 extending circumferentially around the surface 790. A second plurality of chevron shapes 878 is also provided on surface 790 and is axially spaced from the first plurality of chevron shapes 876 by a gap 871.

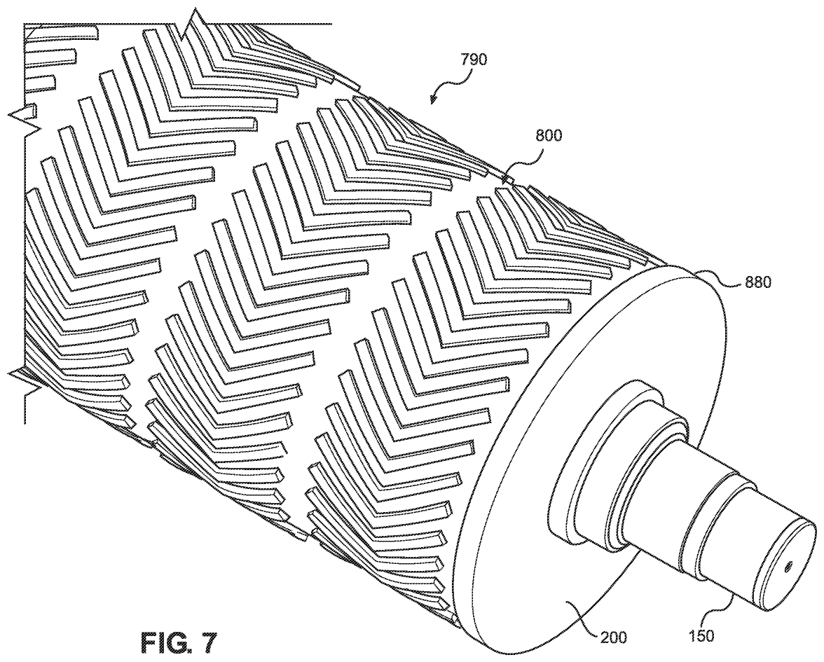

FIG. 7 shows the same generally cylindrical outer surface 790, shown in FIG. 6, on a roller 800. However, an annular ring 880 is shown provided at each end of the surface 790 (only one annular ring 880 being labeled) and also roller 800 is solid. The annular ring 880 rises from surface 790 and is configured to prevent dough from escaping axially when dough 115 is fed to mold roller 122 of FIG. 1.

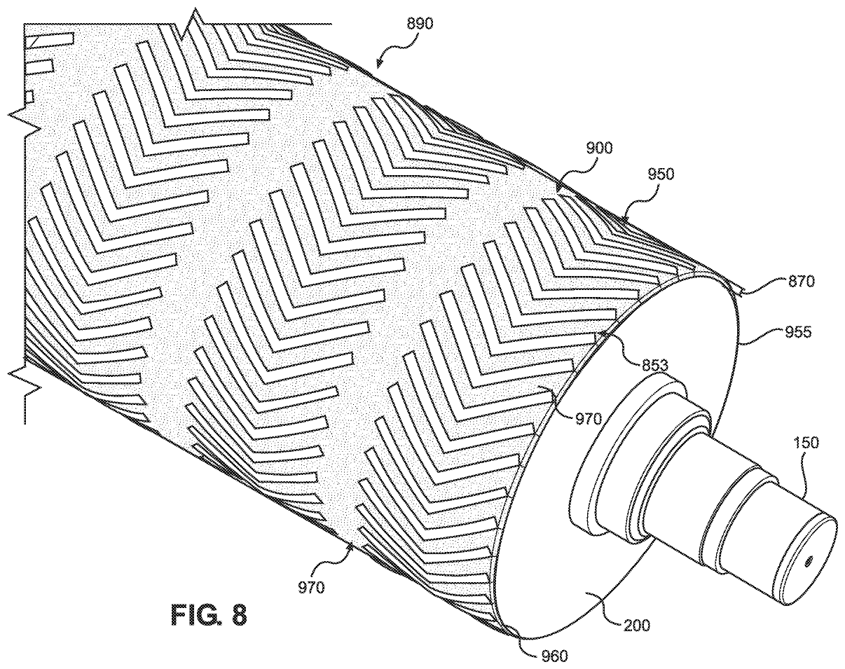

With reference to FIG. 8, there is shown another generally cylindrical outer surface 890 on a roller 900 constructed in a similar manner to the outer surface of FIGS. 6 and 7. Important to this embodiment of the invention is that a plurality or pattern of chevrons 950 is shown extending to the end 955 of surface 890. Extending the pattern of chevron shapes 853 all the way to the end 955 of the surface 890 (FIG. 8) or adding the ring 880 around the end of the surface 790 (FIG. 7), helps keep dough 115 from “escaping.” Also, FIG. 8 shows how some of the dough 960 remains stuck between raised portions, in this case, chevron shapes 853, to form the smooth surface 970. That is, the raised portions, such as chevrons 950 rise to the height 870 which may be chosen to be a certain height, and the raised portions are configured to retain some of the dough 960 between the raised portions up to the certain height to transform the generally cylindrical outer surface 790 into a smooth generally cylindrical outer surface 970. The inventors have surprisingly found that having the outer surface 890 self-clean is undesirable. That is, some of the dough, e.g., portion 960 of dough 115 in FIG. 8, remains stuck on the outer surface 890, filling the pattern of chevrons 950. Ultimately, the pattern of raised portions helps hold the portion of dough 960 on the surface 890 of the roller 121, creating the substantially smooth surface 970, which not only helps move dough 115 along, but the “smooth” surface 970 created by the dough 960 cushions dough 115 so that particulates in the dough 115 are not subjected to any significant crushing, i.e., the particulates stay intact. This cushioning effect simply cannot be replicated by a smooth-surfaced roller, but the result can be obtained by using different raised portions, such as the sinusoidal and chevrons shapes described above.

Based on the discussion above, it should be clear that a method of molding dough 115 with the feed roller 121 and the mold roller 122 includes initially retaining some portion of the dough 115 (e.g., dough portion 960) on the generally outer cylindrical surface 890 of the feed roller 900 between the raised portions such as, for example, chevron shapes 853 of the roller 900, and inserting the rest of the dough 115, i.e., the dough 115 not retained by the raised portions, in cavities 170 located in the mold roller 122. The method further comprises preventing the dough 115 from escaping axially off the roller 121, such as based on the extent of the raised portions and/or with the annular ring 880. Retaining some dough between the chevron shapes 853 also causes the dough 115 to form the smooth surface 970. The dough 115 is protected while being inserted in the cavities 170 because the dough 115 is cushioned with the smooth surface 970. As a result, desirable particulates located within the dough 115 are not crushed during processing. Also, the overall arrangement enables dough 115 to move quickly and efficiently between the feed roller 121 and mold roller 122.

While certain preferred embodiments of the present invention have been set forth, it should be understood that various changes or modifications could be made without departing from the spirit of the present invention. For example, while various described embodiments reference the use a solid roller, multiple shells on a single roller, or even a single shell could be employed to form the generally cylindrical outer surface. In addition, many different structures, not just the chevrons or sinusoidal raised patterns, may be employed to form the raised portions or ridges. In general, the invention is only intended to be limited by the scope of the following claims.

1. A feed roller comprising:
a main body forming a generally cylindrical outer surface of the feed roller having an end portion and extending in a longitudinal direction, the generally cylindrical outer surface having raised portions forming distinct shapes of a certain height, arranged in a pattern that extends circumferentially around the generally cylindrical outer surface and configured to retain some dough between the raised portions up to the certain height to transform the generally cylindrical outer surface into a smooth generally cylindrical outer surface.

2. The feed roller of claim 1, wherein the distinct shapes are chevron shapes, each chevron shape formed of two diagonal legs of raised portions meeting at a point and forming an angle.

3. The feed roller of claim 2, wherein the height ranges between 1 and 5 mm.

4. The feed roller of claim 3, wherein the height ranges between 3 and 3.6 mm.

5. The feed roller of claim 2, wherein the chevron shapes have a width ranging between 3 to 10 degrees along an arc on the cylindrical surface.

6. The feed roller of claim 2, wherein the chevron shapes have a width ranging between 5 and 15 mm.

7. The feed roller of claim 6, wherein the width ranges between 9 and 9.6 mm.

8. The feed roller of claim 2, wherein the chevron shapes include a plurality of chevron shapes arranged in the pattern and extending circumferentially around the surface.

9. The feed roller of claim 8, wherein each chevron shape of the plurality of chevron shapes is circumferentially separated by a gap, the gap being between 5 and 15 mm long.

10. The feed roller of claim 8, wherein an annular ring is formed on the circumferentially extending outer surface between the plurality of chevrons and the end portion of the generally cylindrical outer surface.

11. The feed roller of claim 10, wherein the annular ring extends to the end portion of the generally cylindrical outer surface.

12. The feed roller of claim 8, wherein the plurality of chevron shapes extends to the end portion of the generally cylindrical outer surface.

13. The feed roller of claim 8, wherein the chevron shapes are connected by joints to form a continuous pattern extending longitudinally.

14. The feed roller of claim 8, wherein the plurality of chevron shapes constitutes a first plurality of chevron shapes, and the chevron shapes include a second plurality of chevron shapes which are arranged circumferentially around the surface.

15. The feed roller of claim 1, wherein the distinct shapes form a sinusoidal pattern.

16. A method of molding dough with a feed roller and a mold roller comprising:
feeding dough between the feed roller and the mold roller;
initially retaining some of the dough on a generally cylindrical outer surface of the feed roller between raised portions of the roller to form a smooth generally cylindrical outer surface;
feeding a portion of the dough between the smooth generally cylindrical outer surface and the mold roller; and
inserting the portion of the dough in mold cavities located in the mold roller.

17. The method of claim 16, wherein the generally cylindrical outer surface has raised portions forming distinct shapes of a certain height and arranged in a pattern that extends circumferentially around the generally cylindrical outer surface, and initially retaining some of the dough on the generally cylindrical outer surface includes retaining some of the dough between the raised portions up to the certain height to transform the generally cylindrical outer surface into a smooth generally cylindrical outer surface.

18. The method of claim 16, wherein the raised portions are in chevron shapes and initially retaining some of the dough further includes retaining some of the dough between the chevron shapes.

19. The method of claim 16, wherein inserting the portion of the dough includes inserting the portion of the dough in the mold cavities with the smooth surface and cushioning the portion of the dough with the smooth surface as the portion of the dough is placed in the mold cavities.

20. The method of claim 16, further comprising preventing the dough from escaping axially off the roller with an annular ring.
